(19) United States
(12) Patent Application Publication
(10) Pub. No.: US 2008/0245786 A1
(43) Pub. Date: Oct. 9, 2008

(54) SYSTEM AND METHOD FOR PROVIDING AN ASYMMETRICALLY OR SYMMETRICALLY DISTRIBUTED MULTI/SINGLE ZONE WOVEN HEATED FABRIC SYSTEM HAVING AN INTEGRATED BUS

(75) Inventor: Vikram Sharma, Stoneham, MA (US)

Correspondence Address: SHEEHAN PHINNEY BASS & GREEN, PA;c/o PETER NIEVES, 1000 ELM STREET, MANCHESTER, NH, 03105-3701, US

(73) Assignee: CoZPets LLC, Nashua, NH (US)

(21) Appl. No.: 11/866,928

(22) Filed: Oct. 3, 2007

Related U.S. Application Data
(60) Provisional application No. 60/848,866, filed on Oct. 3, 2006.

(51) Int. Cl. H05B 3/36

(52) U.S. Cl. 219/529; 219/539; 219/544

(57) ABSTRACT

A system and method for providing a woven fabric system is provided. Generally, regarding the structure of the system, the system contains a top fabric layer, a heating element, and a bottom fabric layer. The heating element further contains at least two electrically conductive buses, wherein the electrically conductive buses are parallel to each other, a series of electrical resistive wires located between the at least two electrically conductive buses, and a horizontal electrically conductive bus connecting the at least two electrically conductive buses to each other. The top fabric layer, the heating element, and the bottom fabric layer are connected to prevent the heating element from moving within the system.

### CROSS-REFERENCE TO RELATED APPLICATIONS

This application claims priority to copending U.S. Provisional Application entitled, “ASYMMETRICALLY OR SYMMETRICALLY DISTRIBUTED MULTI/SINGLE ZONE WOVEN HEATED FABRIC ARTICLE WITH INTEGRATED BUS,” having Ser. No. 60/848,866, filed Oct. 3, 2006, which is entirely incorporated herein by reference.

### FIELD OF THE INVENTION

The present invention is related to heaters, and more specifically, is related to heated fabric articles.

### BACKGROUND OF THE INVENTION

Fabric or fibrous heating/warming articles are known, and are provided in different forms such as, but not limited to, electric blankets, heating and warming pads and mats, heated garments, and the like. Typically, these heating/warming articles contain a body defining one or a series of envelopes or tubular passageways into which electrical conductance heating wires or elements have been inserted. In some instances, during formation of the body, the electric conductance heating wires are integrally incorporated into the body, such as by weaving or knitting.

Relatively flexible electric conductance heating wires or elements, which may be provided in the form of a core of insulating material, such as, but not limited to, yarn about which is disposed an electrical conductive element (e.g., a helically wrapped metal wire or an extruded sheath of one or more layers of conductive plastic), have been fabricated directly into the woven or knitted structure of a fabric body. As an example, in U.S. Pat. No. 5,422,462, to Kishimoto, conductive yarns are selectively substituted for warp and/or weft yarns during formation of a woven body. The conductive yarns are then connected at their ends to a source of electrical current. The following further defines traditional fabric articles.

Examples of traditional heated fabric articles available in the market are based on either laid wire technology or Malden Mills technology. The laid wire technology is characterized by electrically conductive wire laid in a fabric layer. Laid wire systems have been available for a significant period of time. Unfortunately, there are severe problems and limitations to the laid wire technology. Laid wire systems run on high voltage and there is a risk of fire if there is any breakages or discontinuities in the conductive wire. Laid wire systems are also rendered useless if there is any discontinuity in the conductive element and they have a harsh feel due to the wire being thick and not very user friendly or aesthetically pleasing and good to touch. In addition, laid wire systems are characterized by: uneven heating, where the system is designed such that there is high heat on the wires to compensate for separation between the wires, thereby resulting in localized high heating and assumption that the heat will spread to other regions of the blanket; the systems are conductively dangerous (e.g., if a child cuts the wire using any device it may be fatal due to high voltage); the wire system also has all wire loops starting and ending at a termination point; and, there are limitations on the number of zones capable in a laid wire system. Further, laid wire systems have a limitation on generation of dual zones, where such systems are generated by creating two separate pathways laid down side by side, an example of which is shown by FIG. 1.

Laid wire systems are also limited in that the conductive wire distribution in each zone is limited to being symmetrical, resulting in each zone having the same layout. Still further, laid wire systems are characterized by limited width, where the final product can be only so wide, since, traditionally, the wider you go the wider the machine has to be. These products are limited in width due to the machines utilized in fabrication and producing wider machines will be extremely cost prohibitive, and not a readily available solution. As an example, if the desired end product is a King Size Article, the fabric needs to be 108″-110″ wide and ×96″-98″ long.” Using the laid wire approach you will need to produce at least a 108″ wide fabric, in which the actual area of heating zone will be much less. There are problems that will be encountered in such an approach. As an example, the conductive element will need to be able to stretch that length. Unfortunately, since the conductive element is rigid and has low flexibility it will be difficult to increase or generate wider widths, specifically, since more conductor length will cause problems of breakages during fiber raising processes. Also, material will be required to be heat set on machines and pulled to generate the width, thereby adding substantial forces on the conductor that will possibly result in breakages.

Malden Mills developed a new generation of heated fabric articles having a knotted conductor element, which addressed to certain extent some of the deficiencies mentioned above for laid wire systems. Specifically, key features of the new Malden Mills system include: low voltage; low risk of fire; a parallel wire layout reducing the probability of product being rendered useless if any of the conductors develops discontinuity; increased safety for children, since the articles will not cause any harm to a child if the child uses any tool to cut or puncture the heating article; and the articles are more aesthetically pleasing, having raised fibrous surfaces and a conductive element hidden between the raised fibrous surfaces, resulting in an improved feel and comfort of the product next to skin.

With regard to width, using a Malden Mills system, if a desired end product is a King Size Article, the fabric needs to be 108″-110″ wide and ×96″-98″ long.” In case of Malden, since they are turning the fabric to generate dual zone this requirement will be a fabric that is not 110″ long, but instead 96-98″ long. There are problems that will be encountered in such an approach. As an example, the conductive element will need to be able to stretch that length, however, since the conductive element is rigid and has low flexibility it will be difficult to increase or generate wider widths and more conductor length will cause problems of breakages during fiber raising processes. Also, material will be required to be heat set on machines and pulled to generate the width, thereby adding substantial forces on the conductor that will possibly result in breakages.

Unfortunately, there are still limitations to the Malden Mills articles, examples of which include at least the following. Since Malden Mills utilizes a non-integrated bus, the bus has to be mechanically attached to conductive elements. The result of having to mechanically attach the bus to each conductive element is a limitation of width of the resulting system, a limitation on zone wire configuration, and a limitation in the number of zones. Specifically, with regard to the limitation of width, in order to produce wider product there will be a necessity to use wider machines. Unfortunately, for raised fabric surfaces such capabilities are very limited. Also, wide width would be required for all the machines in the process that handle the fabric (e.g., nappers, shears, heat setters, etc.), which is a cost prohibitive and time consuming exercise. With regard to the limitation on zones, the parallel wire configuration can be configured to create dual zones but it adds additional complexities where connection has to occur on the top bus and wire has to snake down along the edges into a termination point. An example of this configuration is shown by FIG. 2A. In addition, since the wire is laid in the fabric, the distribution in one zone or two zones is symmetrical and each zone will have same layout. Further, regarding electrical configuration of Malden Mills articles, the single zone created termination points at the edges of the fabric, as is shown by FIG. 2A and in dual zone, as is shown by FIG. 2B, four unique termination points were generated. The two top bus termination points require the wire to snake down along the selvedge to the termination box, which is a very inefficient and time consuming operation and potential to have failures. Specifically, the wires have to travel a long distance to the termination box.

Traditional methodology used to connect layers of fabric include employing lamination of a woven heated panel between two layers of fabric to make a final product. Unfortunately, the lamination between layers results in rigidness and lamination can delaminate with washing.

Thus, a heretofore unaddressed need exists in the industry to address the aforementioned deficiencies and inadequacies.

### SUMMARY OF THE INVENTION

A system and method for providing a woven fabric system is provided. Generally, regarding the structure of the system, the system contains a top fabric layer, a heating element, and a bottom fabric layer. The heating element further contains at least two electrically conductive buses, wherein the electrically conductive buses are parallel to each other, a series of electrical resistive wires located between the at least two electrically conductive buses, and a horizontal electrically conductive bus connecting the at least two electrically conductive buses to each other. The top fabric layer, the heating element, and the bottom fabric layer are connected to prevent the heating element from moving within the system.

Other features and advantages of the present invention will be or become apparent to one with skill in the art upon examination of the following drawings and detailed description. It is intended that all such additional features and advantages be included within this description, be within the scope of the present invention, and be protected by the accompanying claims.

### BRIEF DESCRIPTION OF THE DRAWINGS

Many aspects of the invention can be better understood with reference to the following drawing. The components in the drawing are not necessarily to scale, emphasis instead being placed upon clearly illustrating the principles of the present invention. Moreover, in the drawing, like reference numerals designate corresponding parts throughout the view.

FIG. 1 is a schematic diagram illustrating a prior art laid wire system.

FIG. 2A is a schematic diagram illustrating a prior art single zone Malden Mills system.

FIG. 2B is a schematic diagram illustrating a prior art dual zone Malden Mills system.

FIG. 3 is a schematic diagram illustrating basic building blocks of the heating element portion of the present woven fabric system.

FIG. 4A is a schematic diagram illustrating an example of an asymmetrical heating element distribution.

FIG. 4B is schematic diagram illustrating another example of an asymmetrical heating element distribution.

FIG. 5A is a schematic diagram illustrating an example of a heating element distribution having a horizontal bus.

FIG. 5B is a schematic diagram illustrating an example of a heating element distribution having a horizontal bus with a section cut out.

FIG. 6 is a schematic diagram further illustrating an example of an electrical resistive wire being a bare electrical wire comprising a bundle of conductive filaments.

FIG. 7 is a schematic diagram illustrating an example of electrical resistive wire in accordance with an alternative embodiment of the invention, where the electrical resistive wire includes electrical wires wrapped around a core filament yarn.

FIG. 8 is a schematic diagram illustrating insulative coating being continuous along resistive wire.

FIG. 9A is a schematic diagram illustrating insulative coating being discontinuous along resistive wire.

FIG. 9B is a schematic diagram illustrating discontinuous resistive wire interwoven with a bus.

FIG. 10 is a schematic diagram illustrating size different between width of the bus and the electrical resistive wire, in addition to an open gap of the electrical resistive wire.

FIG. 11 is a schematic diagram further illustrating the present woven fabric system and contact between warp and resistive conductive weft elements therein.

FIG. 12 is a schematic diagram illustrating bus wires, horizontal bus wires, and electrical resistive wires having good electrical contact in their intersection.

FIG. 13 is a schematic diagram illustrating an example of floating horizontal bus wires.

FIG. 14 is a schematic diagram illustrating a multiple bus woven fabric system, in accordance with one exemplary embodiment of the invention.

FIG. 15 is a schematic diagram illustrating another configuration for a multiple bus woven fabric system, having different intersections between warp and weft buses.

FIG. 16 is a schematic diagram illustrating an integrated warp and weft bus fabric.

FIG. 17 is a schematic diagram illustrating a woven fabric system containing an integrated warp and weft bus fabric laminated to fabrics on one or both surfaces of the integrated warp and weft bus fabric.

FIG. 18A is a schematic diagram illustrating a fabric roll having an integrated warp bus.

FIG. 18B is a schematic diagram illustrating a fabric roll having an integrated warp bus and an integrated weft bus.

FIG. 19 is a schematic diagram illustrating an integrated warp and weft bus fabric having a specific connection to achieve two separate zones.

FIG. 20A is a schematic diagram illustrating a woven fabric system having a woven velvet construction.

FIG. 20B is a schematic diagram further illustrating a top integrated warp bus fabric layer.

FIG. 20C is a schematic diagram further illustrating a bottom integrated warp bus fabric layer.

FIG. 21A is a schematic diagram illustrating an example of an integrated warp bus fabric having the dimensions of 60″×30″.

FIG. 21B is a schematic diagram illustrating a 60″×60″ fabric that can be split in the middle, in the warp direction, to generate two 60″×30″ integrated warp bus fabrics.

FIG. 22 is a schematic diagram illustrating an example of an integrated warp and weft bus fabric having selvage, a warp bus, a weft bus, and electrical resistive wires.

FIG. 23 is a schematic diagram further illustrating an example of a woven fabric system, in accordance with one embodiment of the invention.

FIG. 24 is a schematic diagram providing a top view of a center portion of the fabric system of FIG. 23.

FIG. 25 is a schematic diagram providing a close up illustration of intersection between weft and warp yarns for an edge portion of the fabric system of FIG. 23.

FIG. 26 is a schematic diagram illustrating a dual zone woven fabric system, where the system contains two different conductor layout profiles, one for each zone.

FIG. 27 is schematic diagram providing a top view of the system of FIG. 26 having the integrated warp and weft bus fabrics therein transposed between layers of fabric and adhered or mechanically locked by tacking so that the system does not move.

FIG. 28 is a schematic diagram providing a side cross-sectional view of the system of FIG. 27.

FIG. 29A is a schematic diagram providing a cross-sectional view of the system of FIG. 27, where the bottom fabric layer 436 has an insulation filler.

FIG. 29B is a schematic diagram providing a cross-sectional view of the system of FIG. 27, where the top fabric layer 436 has an insulation filler

FIG. 30 is a schematic diagram illustrating the dual zone woven fabric system of FIG. 26, where the system contains two different conductor layout profiles, one for each zone, however, better illustrating the first and second integrated warp bus fabrics.

FIG. 31 is a schematic diagram providing a perspective cross-sectional view of the system of FIG. 30.

FIG. 32 is a schematic diagram illustrating a dual zone woven fabric system, in accordance with an alternative embodiment of the invention.

FIG. 33 is a schematic diagram illustrating an asymmetrically distributed conductive heating element located within a single zone woven fabric system.

FIG. 34 is a schematic diagram illustrating a dual zone woven fabric system having a first and a second asymmetrically distributed conductive heating element.

FIG. 35 is a schematic diagram illustrating a multi-zone woven fabric system.

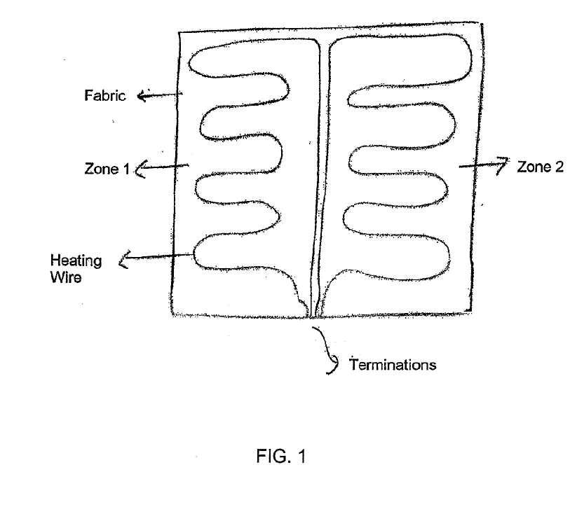

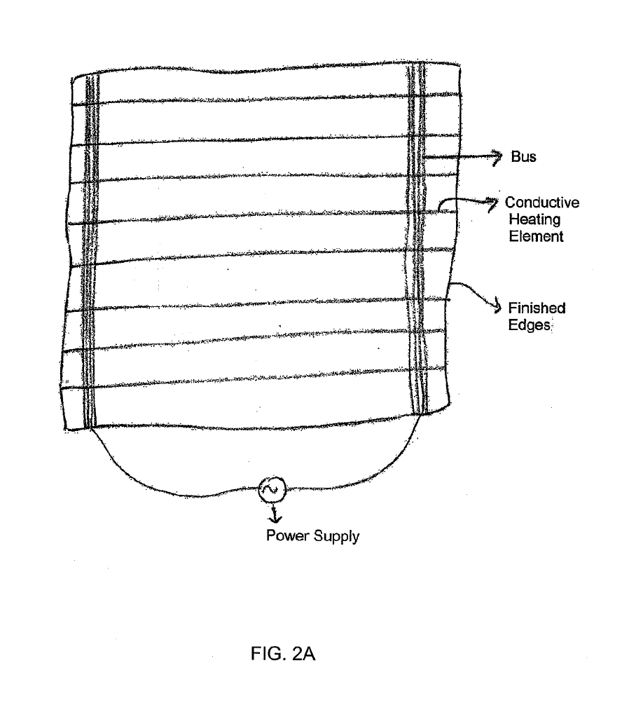

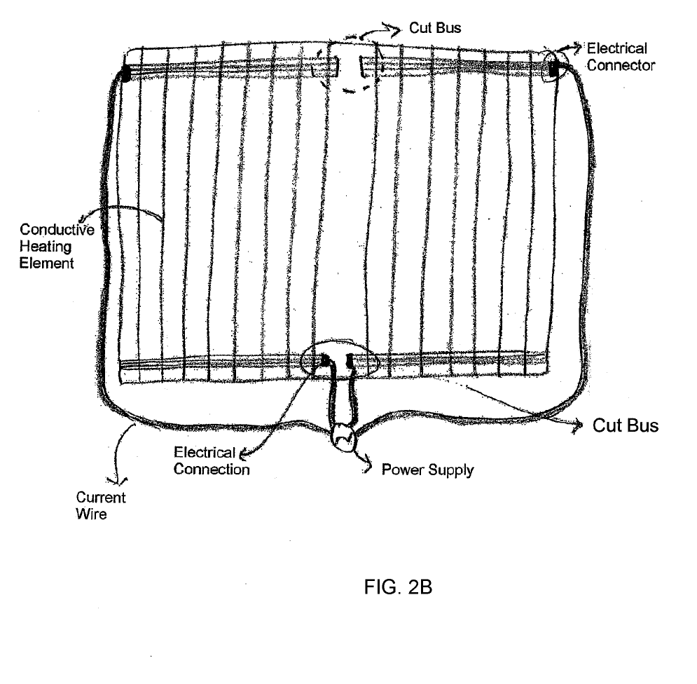

### DETAILED DESCRIPTION

The present system and method provides a woven fabric system adapted to generate heat upon application of electrical power. The system contains elements that provide a unique way to generate multiple heating zones in the system and to have any desired electrical resistive heating element, also referred to herein as a conductive portion, distribution in any zone. The following further describes the system and elements that compose the same.

As is explained in more detail below, the woven fabric system contains a heating element that is inserted in woven fabric in a pre-determined location as a filling (weft) separated by non-electrical conductive yarn, where the non-electrical conductive yarn may act as insulators. The heating element contains electrical conductive wires that are inserted in a warp direction as a bus (also referred to herein as a warp bus), at a pre-determined location, separated by non-electrical conductive yarn, that may act as insulators.

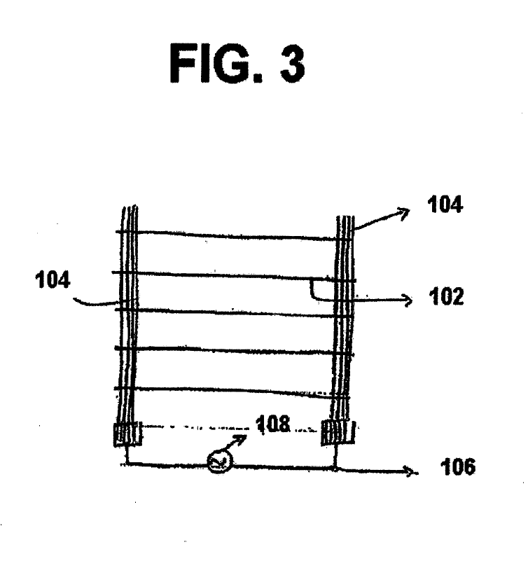

Basic building blocks of the heating element 100 portion of the system are shown by FIG. 3. As is shown by FIG. 3, the heating element 100 contains a series of electrical resistive wires 102 woven in parallel to each other and terminated by two buses 104, thereby generating an electrical circuit that is in parallel. The buses 104 run as a power supply cable to each of the resistive wires 102 and each bus 104 is made of conductive wires that preferably have extremely low impedance. As an example, the conductive wires may be copper wires, copper conductive slit film wrapped around a core filament (tinsel wires) or conductive polymer or metalized yarn such as like Silver coated/impregnated (such as X-Static from Sauquoit or Silver Yarns from Carolina Silver Technologies).

When the two buses 104 are connected through, for example, an electrical cable 106 to a power supply 108, the buses 104 and electrical resistive wires 102 generate heat. It should be noted that the power supply 108 may be an AC or DC power supply. As an example, an AC power supply may be the outlet of a home, while a DC power supply may be a battery.

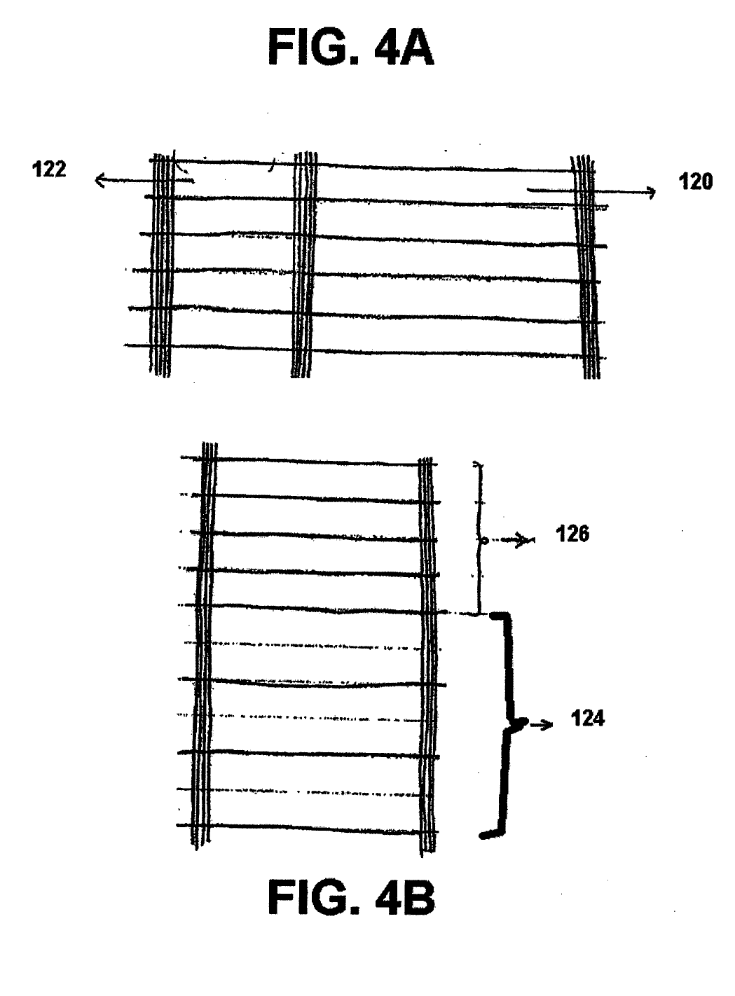

It should be noted that the heating element may have a symmetrical distribution of electrical resistive wires 102 or an asymmetrical distribution. FIG. 4A is a schematic diagram illustrating an example of an asymmetrical heating element 100 distribution, where section 120 is larger than section 122 and will generate different heat in different zones of the system created by such asymmetrical distribution, resulting in different heat per square area of the sections 120, 122.

FIG. 4B is schematic diagram illustrating another example of an asymmetrical heating element 100 distribution that may be used in fabric system construction, where section 124 is larger than section 126. In the example of FIG. 4B, the amount of heat per unit square area will be less on the larger section 124 than in the smaller section 126 having the same watts in each section 124, 126.

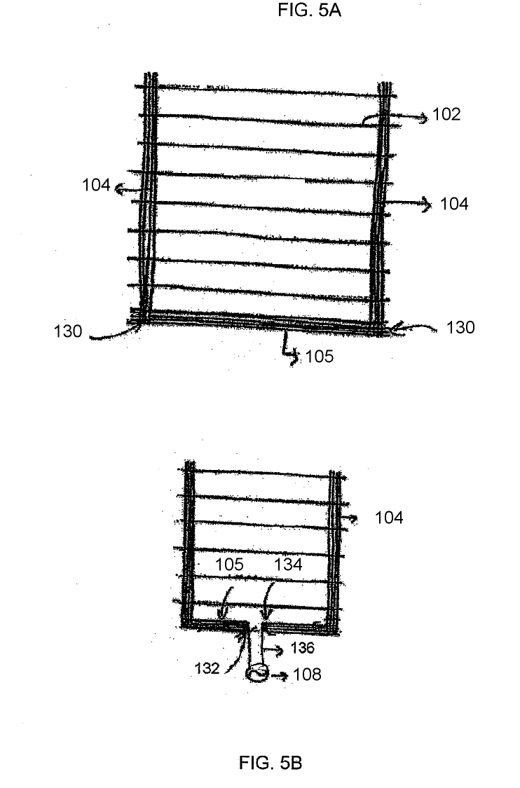

In accordance with an alternative embodiment of the invention, as shown by the schematic diagram of FIG. 5A, the bus 104 may not only be located on both sides of the system (edges of the fabric), perpendicular to the electrical resistive wires 102, but a bus 105 may also be located horizontally, in a position that is parallel to the electrical resistive wires 102. The vertical buses 104 (warp buses) and horizontal buses 105 (weft buses) contact each other at crossing points 130. This configuration provides a parallel circuit where each electrical resistive wire 102 receives an equal amount of current. In addition, the horizontal bus 105 allows for more locations for connection of a power supply to transfer power to generate heat from resistive conductive elements, such as the electrical resistive wire 102.

As is shown by the schematic diagram of FIG. 5B, the horizontal bus 105 may have a section cut out, resulting in a first horizontal bus edge 132 and a second horizontal bus edge 134. Ends of the edges 132, 134 may serve as terminals that may be connected with conductive wires 136 to the power supply 108.

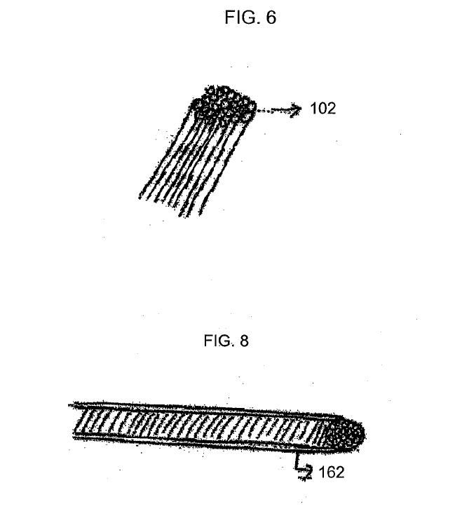

In accordance with the present invention, the electrical resistive wires 142 can be bare electrical wires or can be electrical wires wrapped around a core filament yarn. FIG. 6 is a schematic diagram further illustrating an example of an electrical resistive wire 102 being a bare electrical wire comprising a bundle of conductive filaments. The electrical resistive wire 102 can be made of, for example, bare stainless steel filaments, such as VN 1×90 14 micron-90 filament bundle with ˜70 ohms/meter or any resistive yarn having resistance ranging from 0.01 ohms/meter to 10000 ohms/meter.

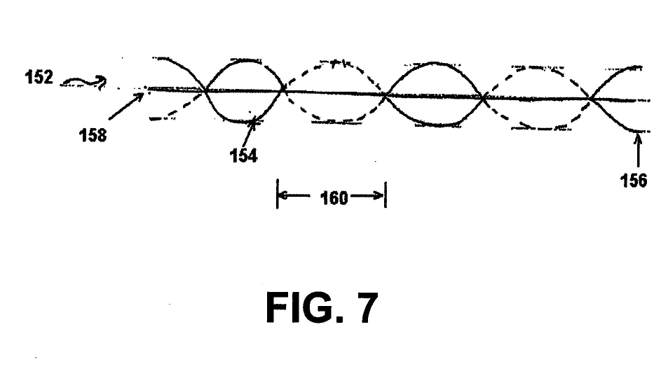

FIG. 7 is a schematic diagram illustrating an example of electrical resistive wire 152 in accordance with an alternative embodiment of the invention, where the electrical resistive wire 152 includes electrical wires wrapped around a core filament yarn (i.e., insulator). As is shown by FIG. 7, the electrical resistive wire 152 may be the combination of a wrap electrical wire 154, a resistive electrical wire 156, and a core filament yarn 158. The core filament yarn 158 is an insulative synthetic or natural fiber/filament yarn, such as, but not limited to, polyester, nylon, and cotton. The core filament yarn 158 can be flat yarn (FOY) or textured filament yarn. The textured filament yarn may be preferred when there is a need to withstand high force that may be asserted on the electrical resistive wire 152 due to mechanical forces in the weaving or manufacturing processes. As an example, electrical resistive wire 152 may be stainless steel wires wrapped around the core filament yarn 158. An example of a configuration may be six wires of thirty-five micron wrapped around 140 Denier Nylon yarn, at 125 ohms/meter or 41×4/140 Nylon at 140 ohms/meter.

The wrap electrical wire 154 and the resistive electrical wire 156 are wrapped around the filament yarn 158, in a pre-determined wrap per meter to obtain a target total resistance, where length of the electrical resistive wire 152 is changed, as well as an open gap 160. The wrap number helps define the size of the open gap 160 and electrical resistance of the electrical resistive wire 152. The wrap can be single conductor wrap or multiple conductor wrap depending on the required end electrical specifications and product requirements.

In accordance with one exemplary embodiment of the invention, the electrical resistive wire 102, 152 can have an insulative coating 162. The insulative coating may be provided by coating with a chemical polymer, such as, but not limited to, Silicone, fluro-carbons, PVC, PVDS and similar compounds.

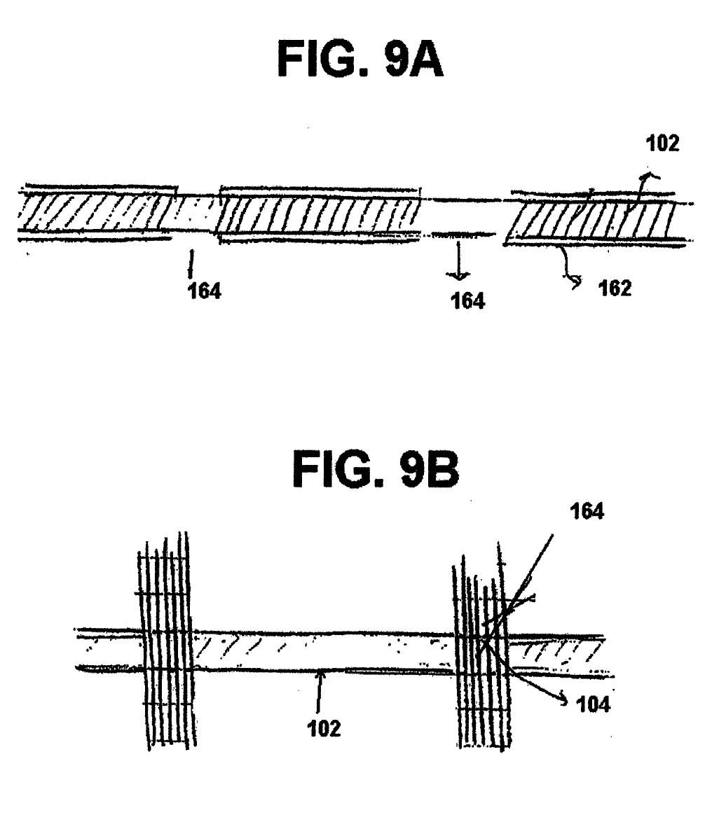

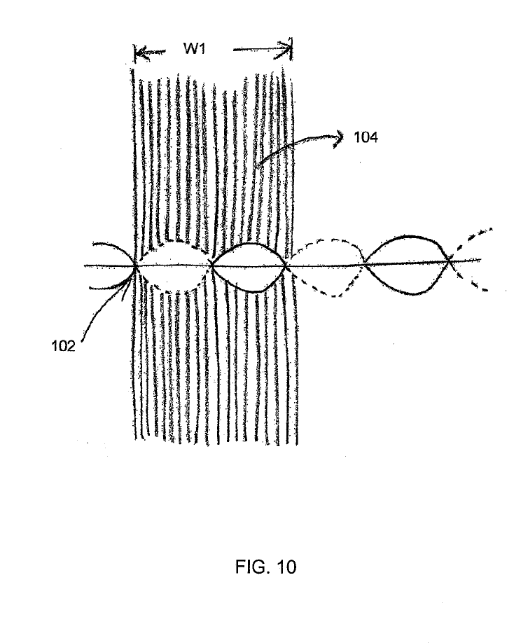

The insulative coating 162 can be continuous along the resistive wire (FIG. 8) or discontinuous (FIG. 9A) where the insulative coating 162 is applied in a pre-determined length and in a predetermined section of the electrical resistive wire 102. Providing an insulative coating 162 may be desirous to achieve integrity of the resistive wire 102, 152 during processing into a woven fabric.

When the insulative coating 162 is discontinuous (FIG. 9A), bare sections 164 will be spaced apart, to match the width of the fabric to which the electrical resistive wire 102 is connected, where the bare sections 164 are interwoven with the bus 104 (FIG. 9B). The bare sections 164 of the electrical resistive wire 102 generate good electrical contact with the bus 104, while the rest of the electrical resistive wire 102 (i.e., the insulated portion) is woven in the textile body (as explained below).

As is shown by FIG. 10, in order to obtain good electrical contact between the bus 104 (warp bus) and the electrical resistive wire 102, 152, width (W1) of the bus 104 is wider than the open gap. The result of having the width (W1) of the bus 104 wider than the open gap of the electrical resistive wire 102, 152 is that no conductive portion of the electrical resistive wire 102, 152 is exposed on either side of the bus 104. To guarantee good electrical contact, it is preferred that the width (W1) of the bus 104 be double the size of the open gap, although other sized widths may be used. It should be noted that the bus 104 needs to be wide enough to ensure continuous probability of connection, intersection, and contact between the two conductive elements (i.e., the bus 104 and the electrical resistive wire 102, 152) to ensure the flow of electricity into the conductive elements to generate heat.

In accordance with an alternative embodiment of the invention, the insulated electrical resistive wire 102, 152 may be incorporated across the whole width of the woven fabric, where in the intersection with the bus 104, the insulative coating 162 of the electrical resistive wire 102, 152 is displaced, dissolved, melted, treated, or mechanically modified to get the good electrical contact.

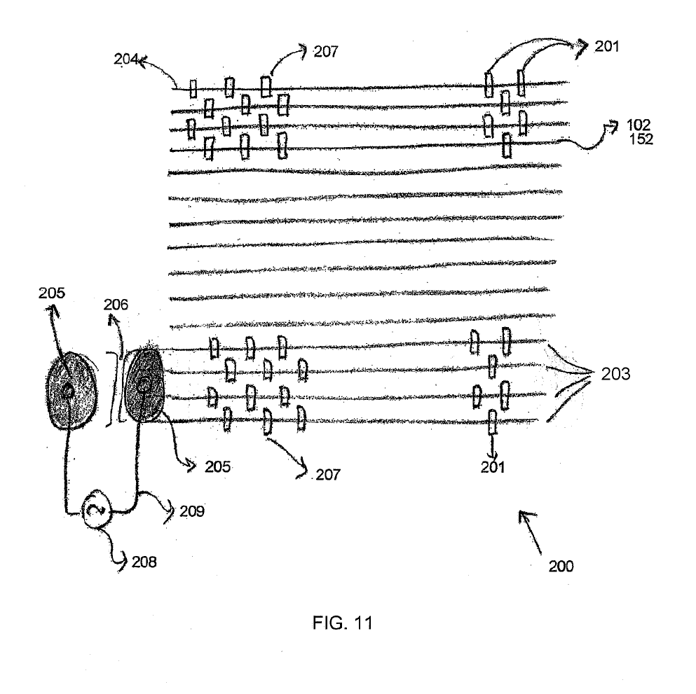

FIG. 11 is a schematic diagram further illustrating the present woven fabric system 200 and contact between warp and resistive conductive weft elements therein. As is shown by FIG. 11, the electrical resistive wire 102, 152 (i.e., electrical heating element) is woven in a filling direction, where non-conductive yarn 207 holds the electrical resistive wire 102, 152 in place, in a warp direction. A first highly conductive wire(s) 201 is woven in the warp direction and intersects with the electrical resistive wire 102, 152. The first highly conductive wire 201 in the warp direction intersects with the second highly conductive wire 203, to have very good electrical contact. The first highly conductive wire 201 and the second highly conductive wire 203 can have the same electrical conductivity or different electrical conductivity, but still very low electrical resistance. In addition, the non-conductive yarn in the warp direction 207 and non-conductive yarn in the filling direction 204 is used throughout the whole textile fabric of the woven fabric system 200, in addition to in between spaced apart electrical resistive wires 102, 152, and over the second highly conductive wires 203.

The first highly conductive wires 201 are woven into a group to generate an electrical bus. The second highly conductive wires 203 are woven into a group in the filling direction, generating an electrical bus that is perpendicular to the bus of the first highly conductive wires in the warp direction 201. The non-conducting yarn 207 can be finer, the same, or coarser than the second highly conductive wires 203, and electrical resistive wires 102, 152. The non-conductive yarn 207 is preferred to be bulkier and coarser than the second highly conductive wires 203 and the electrical resistive wires 102, 152, to create an offset similar to generating insulation or to insulate them and to protect them from an electrical short circuit in case non-insulated conductive wires are used. The non-conductive yarn 207, 204 can be made of synthetic yarn, natural yarns, regenerated yarn in the filament, multifilament or spun and/or a blend thereof. The non-conductive yarn 207, 204 may also be made of other materials.

As is shown by FIG. 11, the second highly conductive wires 203 in the horizontal bus can be terminated, thereby generating a terminal 205, by disconnecting the wires 203 at any pre-determined location along the horizontal bus to provide a gap 206. Having two terminals 205 in the same region reduces the need for long wires running from the edges of the bus. Electrical cable 209 may be provided to connect two terminals 205 to a power supply 208. The power supply 208 can be an AC power supply such as, but not limited to an electrical outlet, a DC power supply such as, but not limited to, a battery, or combination of each. The terminals 205 can be made of a metallic snap that generates contact with the horizontal bus wires 203. The terminals 205 can be unraveled highly conductive wires that can be either mechanically, chemically, or a combination of mechanically and chemically connected to a connector, power supply, or any other electrical or mechanical device that allows for current to flow into the woven fabric with conductive electrical wires and yarns.

In accordance with the present invention, the woven construction of the woven fabric system 200 can be at any standard weave. As an example, the woven fabric system 200 may be basket weave, twill, satin, oxford, gabardine, or any other combination in the same woven textile, at pre-determined regions in the fabric or textile.

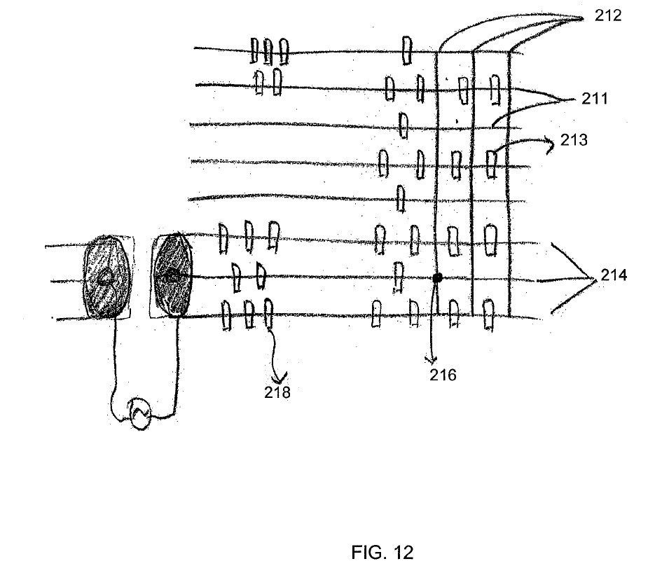

In accordance with an alternative embodiment of the invention, as shown by FIG. 12, bus wires 212, and the horizontal bus wires 214 (and the electrical resistive wires, heating element 211) are inserted with good electrical contact in their intersection 216, as well as being held tightly and secured by non-conductive yarns 213.

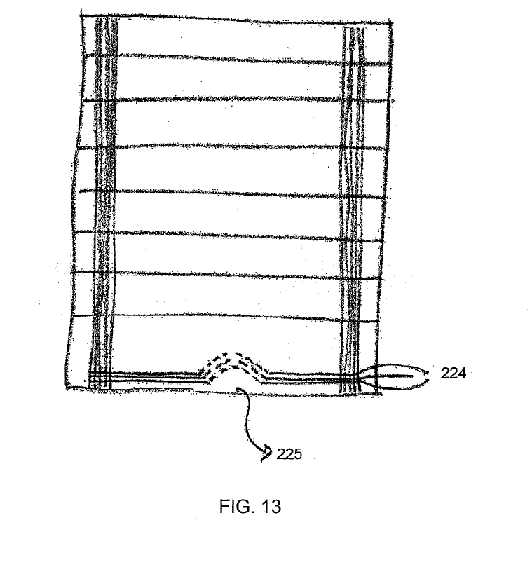

In accordance with another alternative embodiment of the invention, as shown by FIG. 13, horizontal bus wires may be floating 225 (come out of the fabric construction) at any pre-determined point, and at any pre-determined length, while other sections of the horizontal bus are woven in and secured in the weave of the textile with the non-conductive yarns. The floating bus wires 224 may be cut and terminated, and connected to a power supply by electrical cables.

In accordance with the present invention, the woven heating unit (the bus in warp direction and/or filling direction), the electrical heating wires and the non-conductive yarn, can be used as a stand alone heating panel connected to a power supply, inserted in-between other textile construction, or inserted and laminated between two other textile materials or any two material systems. Other materials, such as, but not limited to, textiles, above and under the electrical heating element can be smooth plain fabric (e.g., woven, knit) or raised surface textile construction on one side or both sides.

The present woven fabric system heating panel can include elastomeric yarn in the filling direction and/or warp direction to provide a heat panel having stretch capabilities, where the system is capable of stretching and recovering. Similarly, the conductive yarn made with wraps around the core yarn can have the core yarn contain elastomeric properties to allow for stretchable conductive yarn in the woven construction.

FIG. 14 is a schematic diagram illustrating a multiple bus woven fabric system 250, in accordance with one exemplary embodiment of the invention. This configuration of fabric system 250 may be desired specifically for special controls to control the way the fabric is heated. It should be noted that any number of warp buses 252 and weft buses 254 may be provided as desired, in any configuration. As is shown by FIG. 14, multiple electrical resistive wires 256 are located between parallel warp buses 252. In addition, multiple power supplies 258 may be provided.

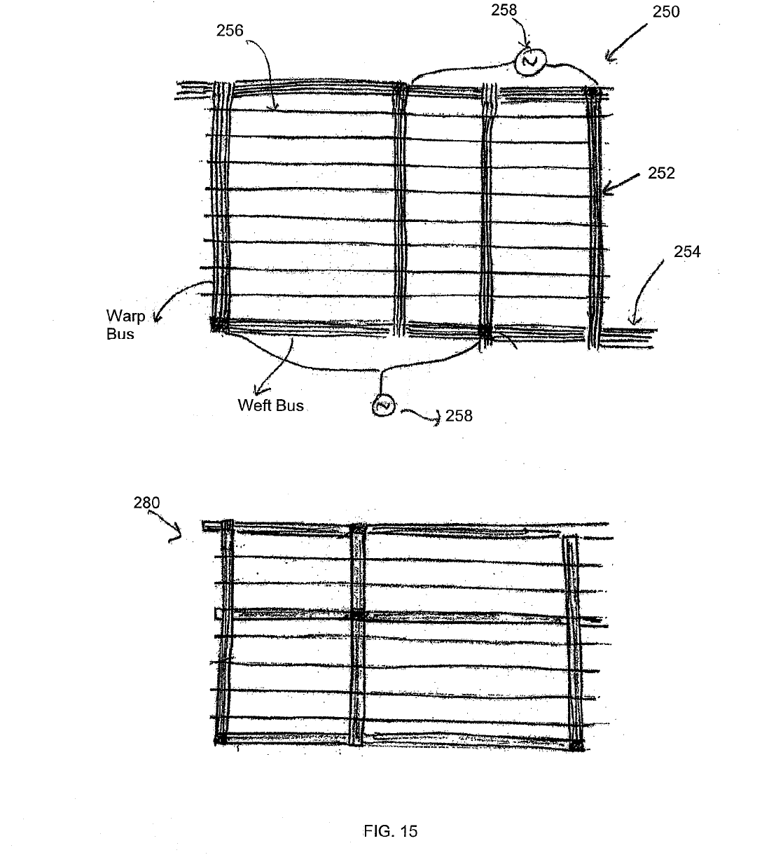

FIG. 15 is a schematic diagram illustrating another configuration for a multiple bus woven fabric system 280, having different intersections between warp and weft buses.

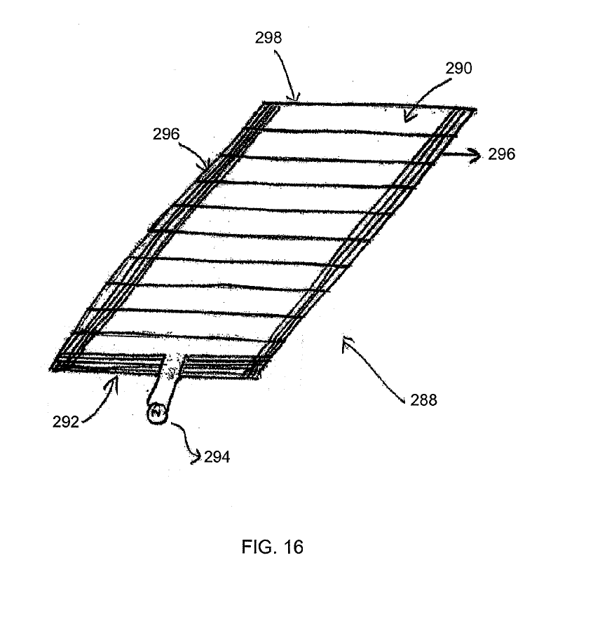

FIG. 16 is a schematic diagram illustrating an integrated warp and weft bus fabric 288. As is shown by FIG. 16, fabric 290 can be used as itself by incorporating discontinuity in a weft bus 292 at desired locations and connecting the weft bus 292 to a power supply 294. The weft bus 292 intersects warp buses 296 having electrical resistive wires 298 therebetween. Since the electrical resistive wires 298 are in parallel configuration, the amount of power running through the wires 298 is extremely low. It should be noted that in accordance with an alternative embodiment of the invention, the system 288 of FIG. 16 may instead be provided without a weft bus.

In accordance with one embodiment of the invention, the integrated warp and weft bus fabric may be treated with a finish or coating. The coating and/or finish may be provided for aesthetic purposes or any other fabric performance properties as desired, such as, but not limited to, waterproofing, breathability, and wind blocking.

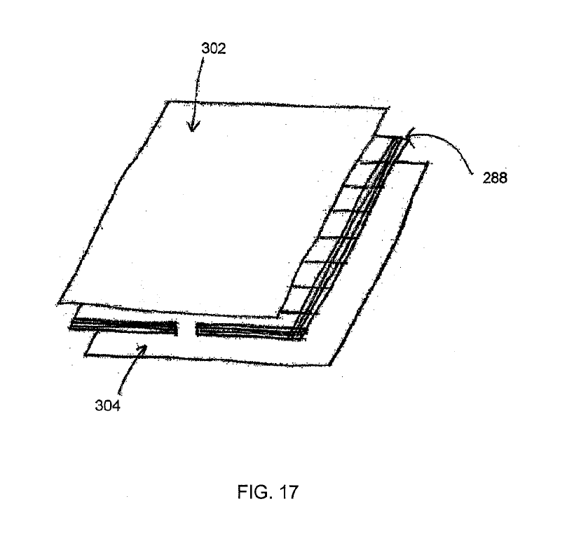

In accordance with the present invention, a woven fabric system may contain an integrated warp and weft bus fabric laminated to fabrics on one or both surfaces of the integrated warp and weft bus fabric, as shown by FIG. 17. As shown by FIG. 17, the fabrics comprise a top layer fabric 302 and a bottom layer fabric 304, on each side of the integrated warp and weft bus fabric 288.

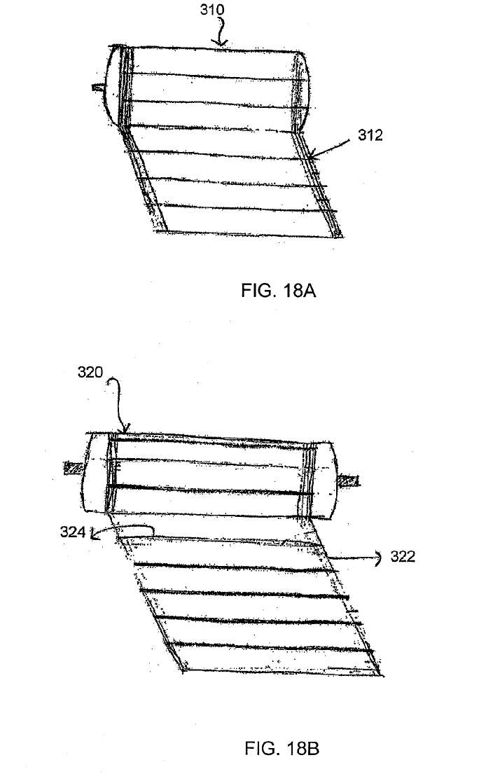

As is shown by FIG. 18A and FIG. 18B, the fabric rolls may be prefabricated prior to use. FIG. 18A is a schematic diagram illustrating a fabric roll 310 having an integrated warp bus 312. Alternatively, FIG. 18B is a schematic diagram illustrating a fabric roll 320 having an integrated warp bus 322 and an integrated weft bus 324. It should be noted that the fabric rolls may also have selvedges and/or other elements defined herein.

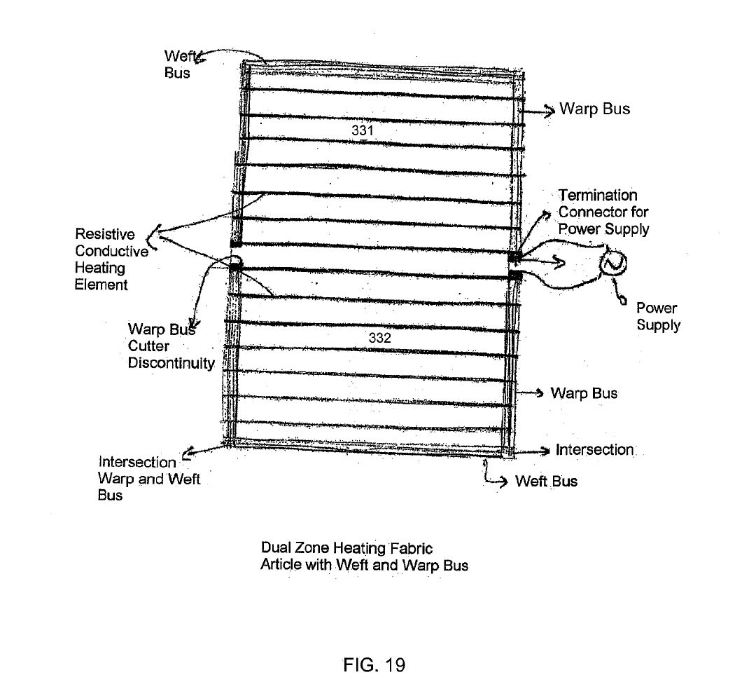

FIG. 19 illustrates an integrated warp and weft bus fabric 330 having a specific connection to achieve two separate zones 331, 332. Each zone can be independently operated, thereby providing users on each side of the fabric 330 with their desired level of heating. It should be noted that construction may be done to achieve more than two zones by incorporating additional weft buses and warp buses. A power supply 333 is also illustrated by FIG. 19.

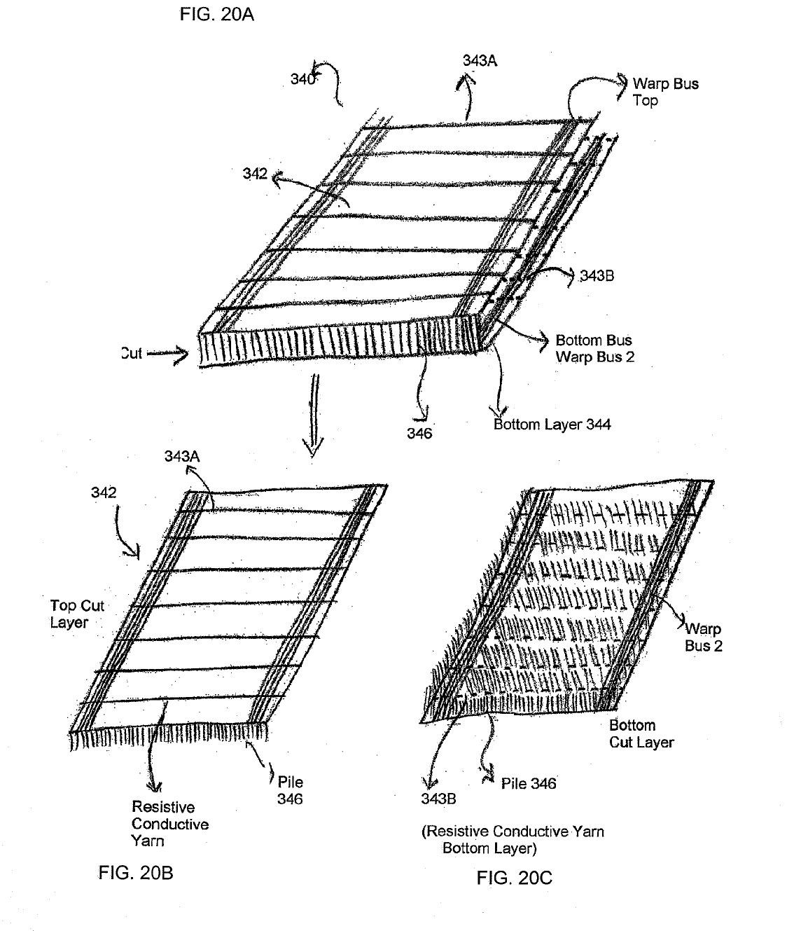

FIG. 20A is a schematic diagram illustrating a woven fabric system 340 having a woven velvet construction. The woven velvet construction achieves a pile surface in integrated warp bus fabric layers 342, 344 to remove the need to brush, nap or provide any mechanical action to generate pile or surface fiber on the fabric surface. FIG. 20B further illustrates a top integrated warp bus fabric layer 342, while FIG. 20C further illustrated a bottom integrated warp bus fabric layer 344. It should be noted that each of the integrated warp bus fabric layers 342, 344 is independent of each other.

As is shown by FIG. 20A, there is a pile layer 346 that holds the top and bottom warp bus fabric layers 342, 344 together and separate. During fabrication, the pile layer 346 is cut in the middle to provide two fabric layers, resulting in each fabric layer 342, 344 having a pile surface on it.

It should be noted that the integrated warp and weft bus fabrics and/or the integrated warp bus fabrics may have different dimensions. Examples of such dimensions may include, but are not limited to, 15″×14″, 6″×10″, 7″×4″, 60″×60″, and 60″×30″. It should be noted that these dimensions are only provided for exemplary purposes and are not intended to limit dimensions of the present invention. In fact, the integrated warp and weft bus fabrics and/or the integrated warp bus fabrics may have any width and length.

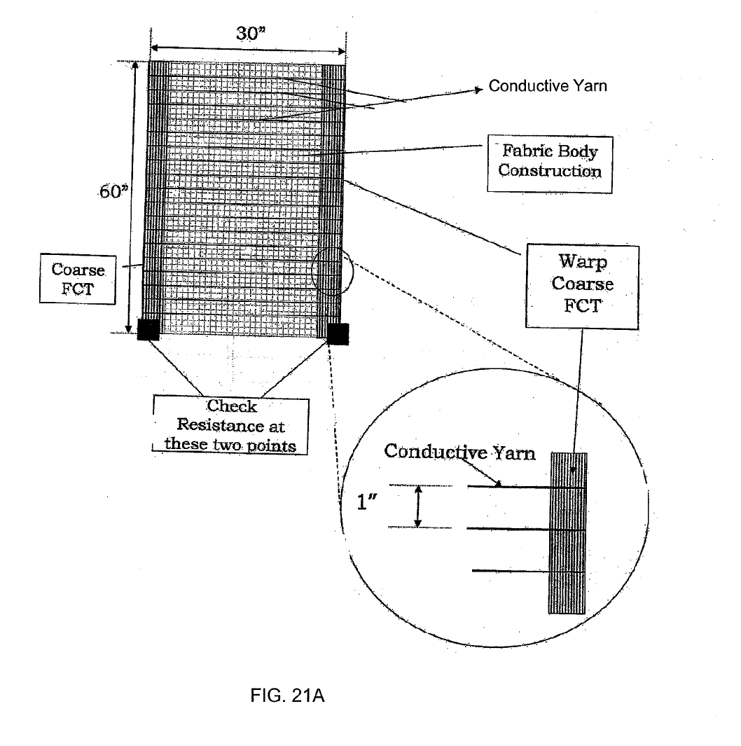

For exemplary purposes, FIG. 21A is provided, which illustrates an example of an integrated warp bus fabric 350 having the dimensions of 60″×30″. Also for exemplary purposes, the conductive yarns are approximately one inch apart, providing a target resistance of approximately six ohms. In addition, FIG. 21B is a schematic diagram illustrating a 60″×60″ fabric 360 that can be split in the middle, in the warp direction, to generate two 60″×30″ integrated warp bus fabrics.

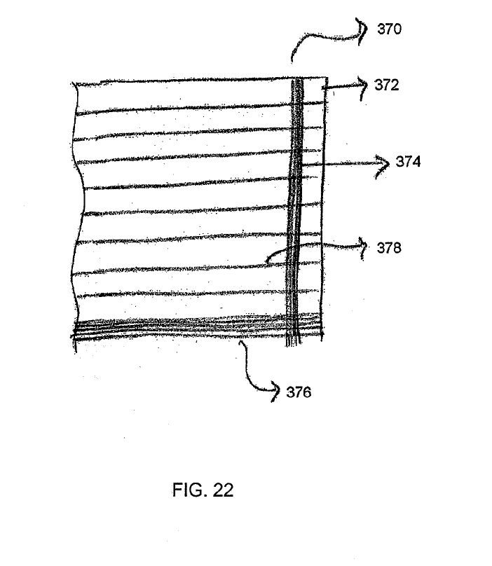

In accordance with the present invention selvage may be provided on the integrated warp and weft bus fabric and/or the integrated warp bus fabrics to allow for sewing to other fabrics without interfering with the conductive circuits. In addition, selvedge may also be used for binding the fabric to avoid any movement of the fabric or for purposes of aesthetics. FIG. 22 is a schematic diagram providing an example of an integrated warp and weft bus fabric 370 having selvage 372, a warp bus 374, a weft bus 376, and electrical resistive wires 378.

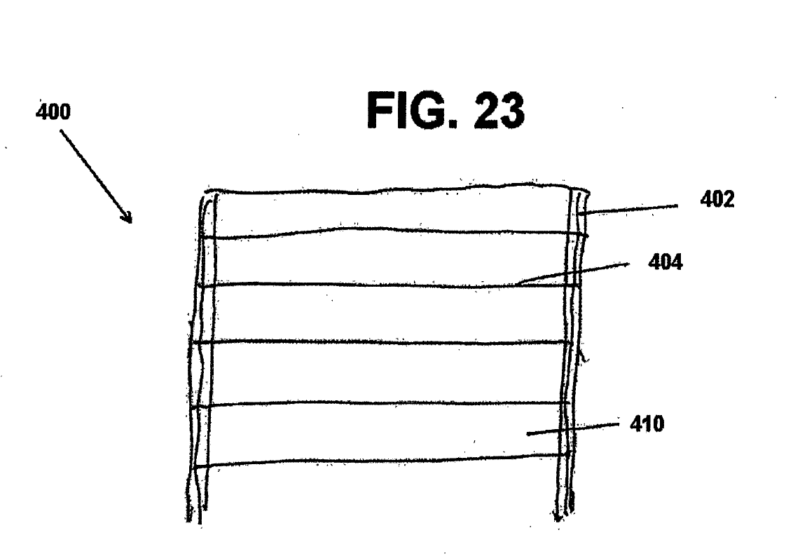

FIG. 23 is a schematic diagram further illustrating an example of a woven fabric system 400, in accordance with one embodiment of the invention. As is shown by FIG. 23, the system 400 contains a warp bus 402, a conductive resistive element 404, and insulative warp and weft yarns 410. The insulative warp and weft yarns 406 are other yarns that form the fabric other than the conductive element.

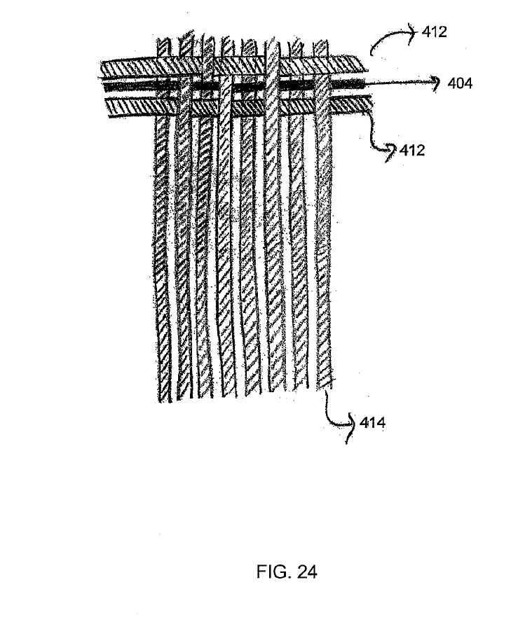

FIG. 24 is a schematic diagram providing a top view of a center portion of the fabric system 400 of FIG. 23. As is shown by FIG. 24, the center portion of the fabric system 400 contains an interlaced cross pattern of the conductive resistive element 404, insulative weft yarn 412 and insulative warp yarn 414. It should be noted that this pattern is only provided for exemplary purposes and that other pattern may instead be provided. It should also be noted that there may be a diameter difference between different yarns. As an example, the conductive yarns may be thinner or thicker depending on what is used (100% metal filaments, wrapped conductive yarns, or coated conductive yarns).

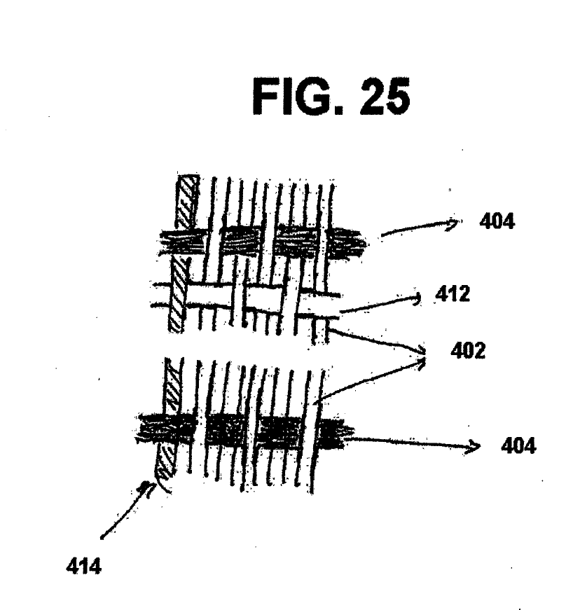

FIG. 25 is a schematic diagram providing a close up illustration of intersection between weft and warp yarns for an edge portion of the fabric system of FIG. 23. As is shown by FIG. 25, the conductive element is interwoven on the warp conductive elements to create a stable and durable contact such that it does not move. Specifically, the edge portion of the fabric system 400 contains an interlaced cross pattern of the conductive resistive elements 404, insulative weft yarn 412, insulative warp yarn 414, and the conductive warp bus 402. Weave selection from various known arts of fabric construction can be used to develop such contact.

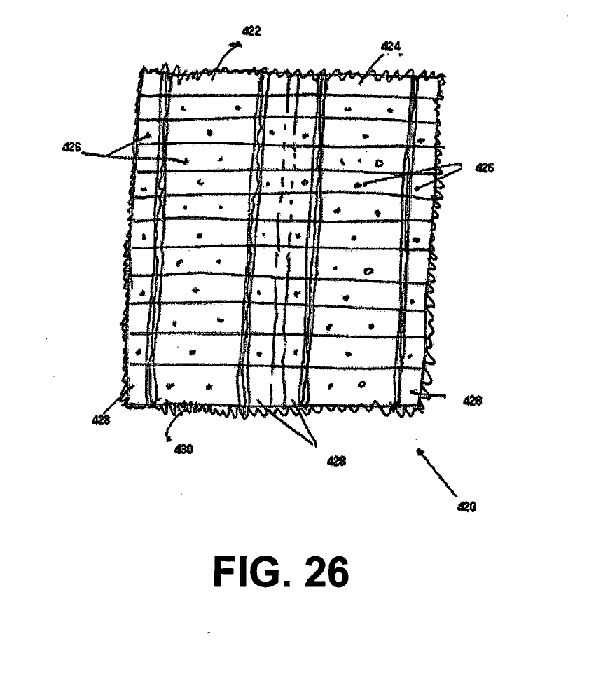

FIG. 26 is a schematic diagram illustrating a dual zone woven fabric system 420, where the system 420 contains two different conductor layout profiles, one for each zone 422, 424. The system 420 contains two integrated warp and weft bus fabrics disposed between top and bottom fabric layers, and then combined using a tacking technique. The tacking technique can be provided by using any mechanism resulting in tack points 426. The distribution of tacking can be as desired. The system 420 can have a zone on each side of a warp bus—where there is no conductor (as a part of circuit) that can be used for sewing without the worry of breaking the conductors. The system 420 of FIG. 26 also illustrates a selvage zone 428 and finished edges 430. It should be noted that each zone 422, 424 can have its own unique heating conductor distribution.

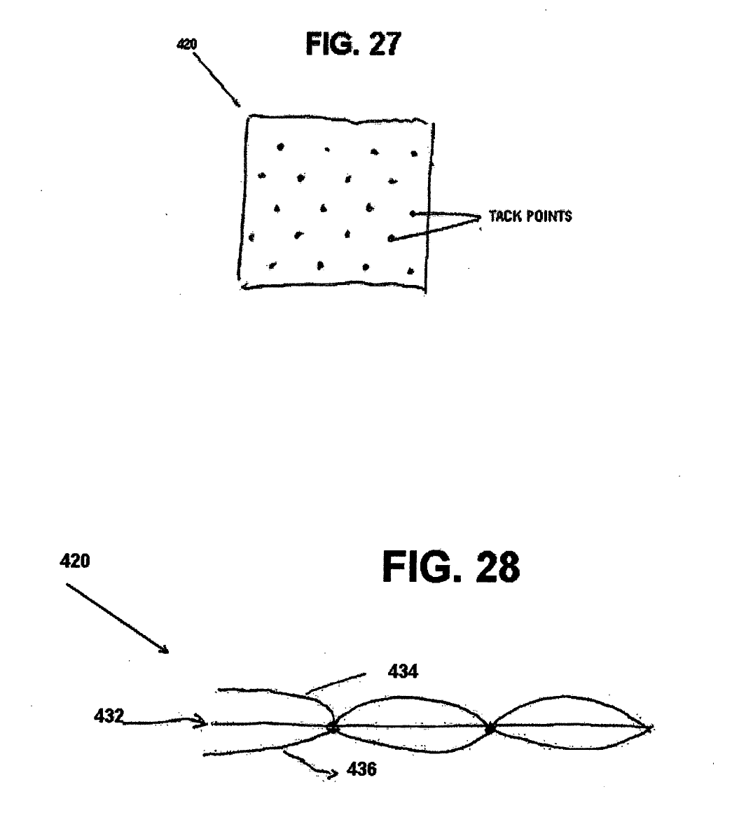

FIG. 27 is a top view of the system 420 of FIG. 26 having the integrated warp and weft bus fabrics therein transposed between layers of fabric and adhered or mechanically locked by tacking so that the system does not move.

FIG. 28 provides a side cross-sectional view of the system 420 of FIG. 27. As shown by FIG. 28, the system 420 contains the integrated warp and weft bus fabrics 432, a top fabric layer 434, and a bottom fabric layer 436. It should be noted that an outer surface of the top fabric layer 434 may be raised and/or an outer surface of the bottom fabric layer 436 may be raised.

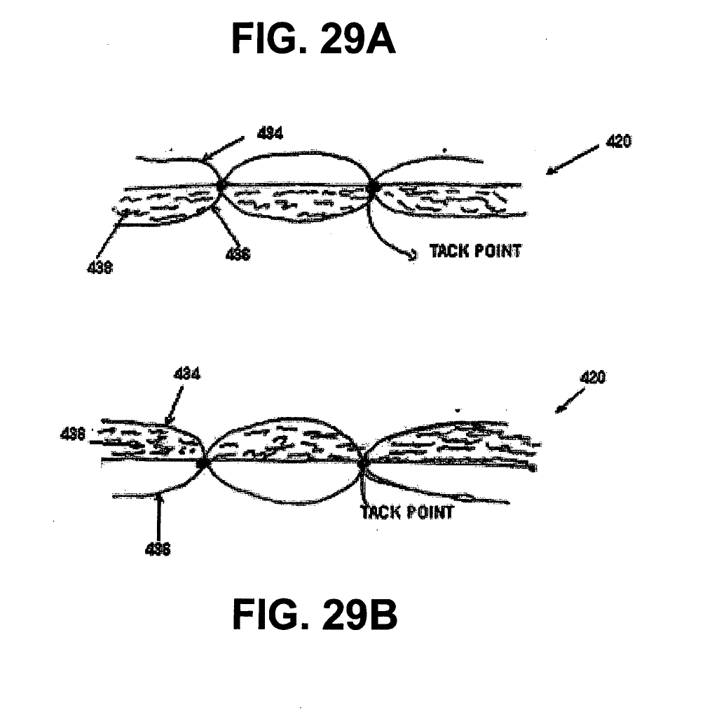

FIG. 29A and FIG. 29B are side cross-sectional views of the system 420 of FIG. 27, where filler material is incorporated for additional insulation. Specifically, FIG. 29A illustrates the system 420 where the bottom fabric layer 436 has an insulation filler 438 and FIG. 29B illustrates the system 420 where the top fabric layer 434 has the insulation filler 438.

It should be noted that in accordance with an alternative embodiment of the invention, the system 420 may instead only contain the integrated warp and weft bus fabrics 432 and either the top or bottom fabric layer 434, 436, but not both. In addition, the top or bottom fabric layer 434, 436 may, or may not, contain filler material.

In accordance with an alternative embodiment of the invention, instead of using an insulation filler, an air gap may be provided within the top fabric layer and/or the bottom fabric layer. Providing an air gap provides a heat retention feature, where a higher air gap results in higher heat retention, while a lower air gap results in lower heat retention.

In accordance with the present invention, tack distribution may take one of many different looks, and the tack distribution may be varied in accordance with desired aesthetic look and feel. As an example, tack distribution may be in a dot pattern or a flat line pattern, or any other size or configuration for that matter. In addition, tacking can be full length along fabric length on a top portion, a bottom portion, or both.

In addition to the abovementioned, a tack may be provided by one of many different methods. Such methods may include, but are not limited to, use of thread, heating adhesive at points for generating tacks, using adhesive, non-woven, glue strips to generate wide tack regions, using a chemical link to generate tacks, and using a mechanical device such as a snap to generate tacks. Of course, any combination of the above methods may be combined to provide the tacks.

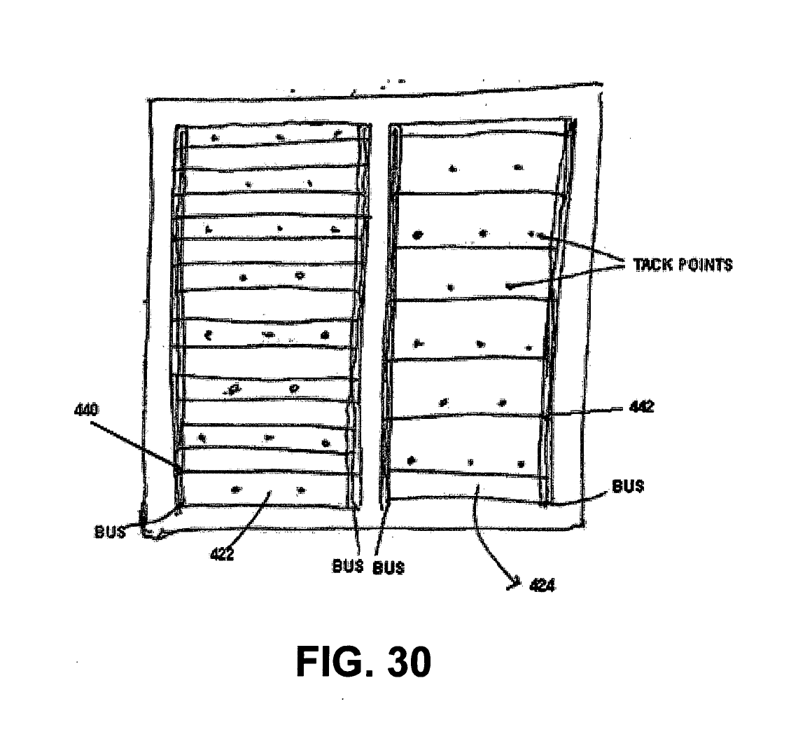

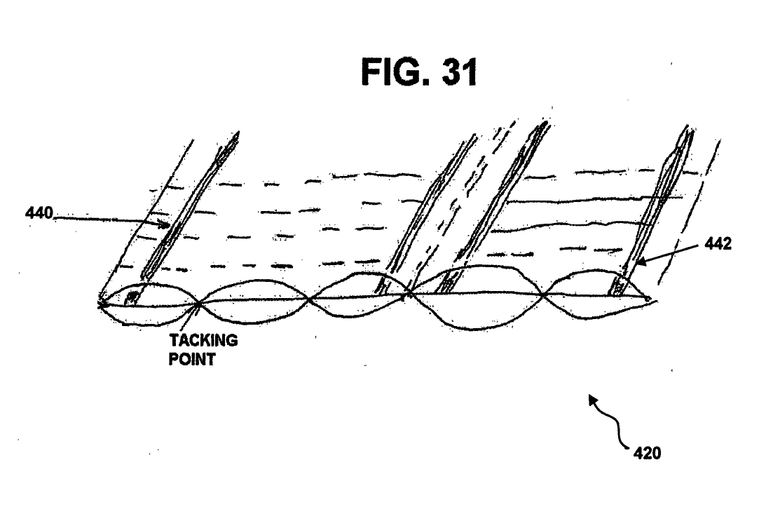

FIG. 30 is a schematic diagram illustrating the dual zone woven fabric system 420 of FIG. 26, where the system 420 contains two different conductor layout profiles, one for each zone 422, 424, however, better illustrating the first and second integrated warp bus fabrics 440, 442. In addition, FIG. 31 is a perspective cross-sectional view of the system 420 of FIG. 30.

FIG. 31 is a schematic diagram illustrating a triple zone woven fabric system 450 in accordance with an embodiment of the invention. As shown by FIG. 31, there are three different heating zones 452, 454, 456, where each heating zone has a different conductive element configuration.

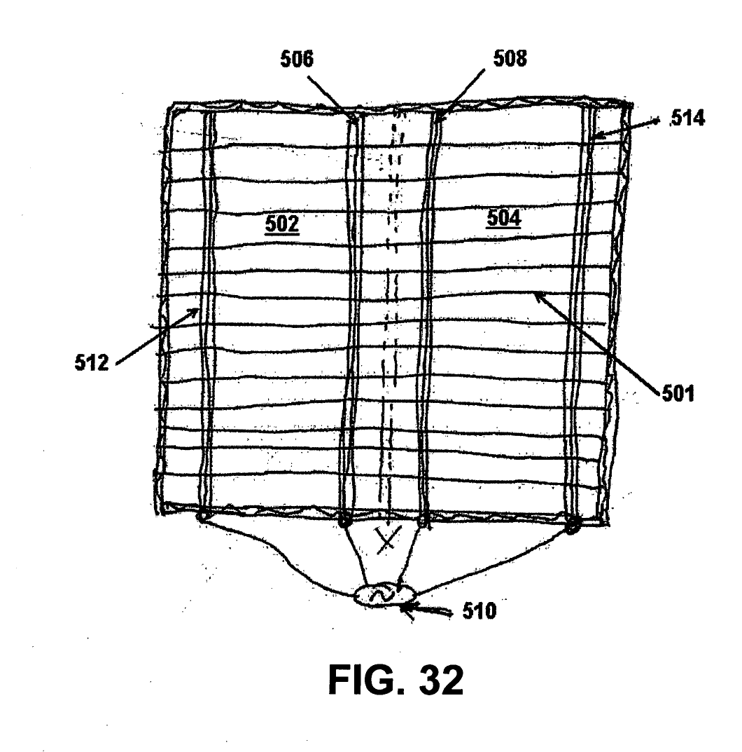

FIG. 32 is a schematic diagram illustrating a dual zone woven fabric system 500 in accordance with an alternative embodiment of the invention. The system 500 of FIG. 32 has a similar distribution of conductive heating element 501 distribution in both the first zone 502 and the second zone 504. The dual zone is created by splitting between a first bus 506 and a second bus 508 in the center to create two unique separate heating panels. FIG. 32 also illustrates a power supply 510 that is connected to the first bus 506 and the second bus 508, in addition to a third bus 512 and a fourth bus 514. In addition

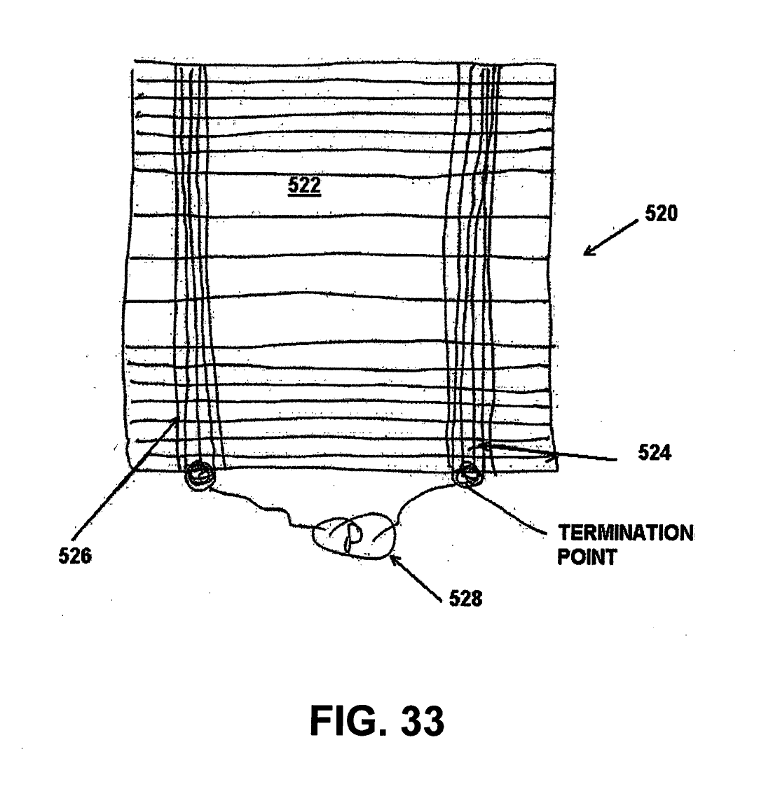

FIG. 33 is a schematic diagram illustrating an asymmetrically distributed conductive heating element 522 located within a single zone woven fabric system 520. The system 520 contains a first warp bus 524, a second warp bus 526, and a power supply 528.

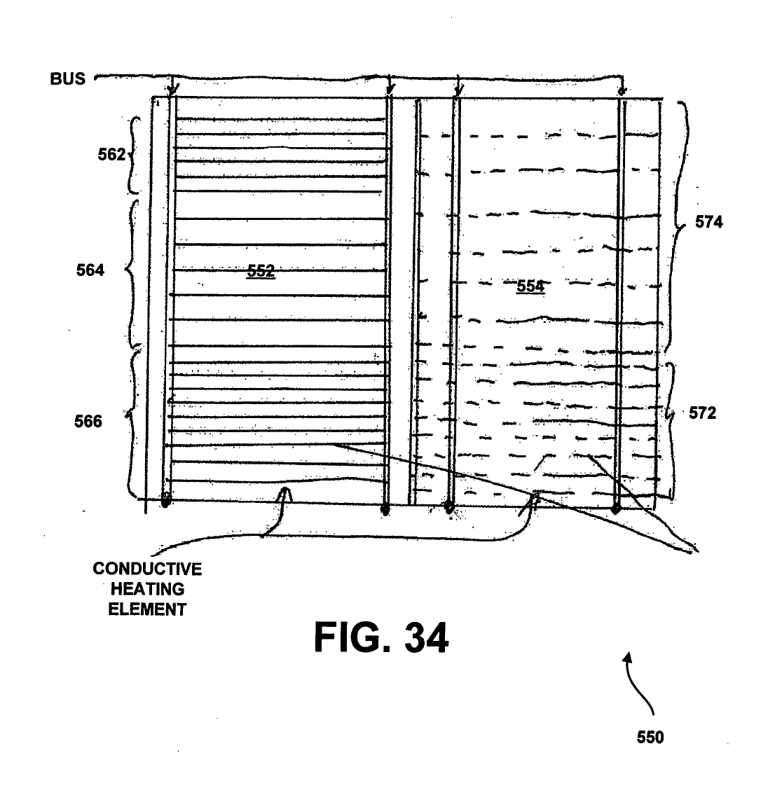

In accordance with an alternative embodiment of the invention, FIG. 34 illustrates a dual zone woven fabric system 550 having a first and a second asymmetrically distributed conductive heating element 552, 554. The first asymmetrically distributed conductive heating element 552 has a first high-density area 562, a low-density area 564, and a second high-density area 566. In addition, the second asymmetrically distributed conductive heating element 554 has a high-density area 572 and a low-density area 574.

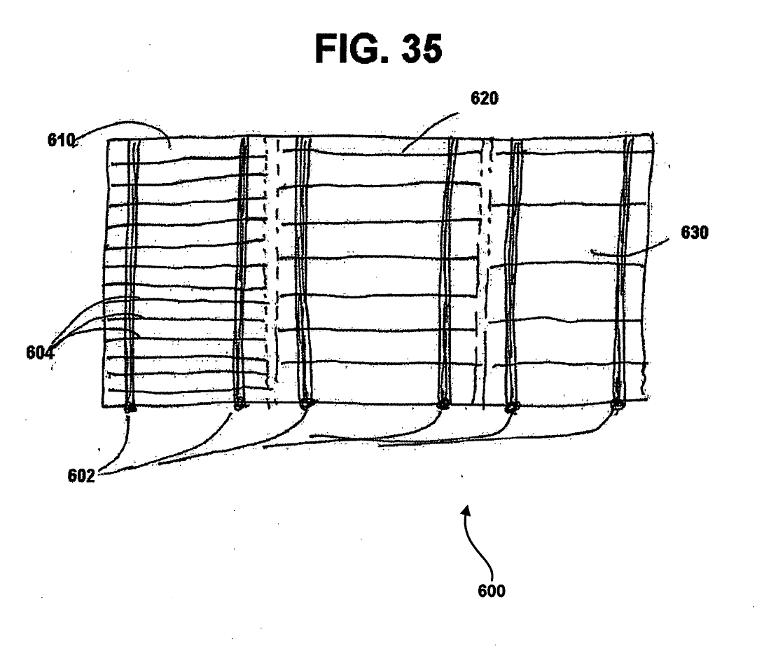

In accordance with another alternative embodiment of the invention, FIG. 35 illustrates a multi-zone woven fabric system 600 having a first heating fabric article 610, a second heating fabric article 620, and a third heating fabric article 630. The system 600 also contains a series of termination points 602 and a series of conductive elements 604.

As a result of the abovementioned embodiments and configurations, the present invention provides a solution to former limitations in width of single zone and multi zone woven heated fabric systems. Specifically, since different heating elements can be tacked to each other or fabric layers it gives the flexibility to produce any size fabric width and combine them to generate any size final product. This system does not get affected by the final length of the product required and number of zones desired in the system.

Benefits of tacking to combine layers, in accordance with the present invention include the distribution of the heating element, where, by generating two heating panels with different patterns of distribution of the conductive heating element and combining them together with tacking with top and or bottom layers we can generate a truly asymmetrical dual zone heating fabric article.

As shown in the abovementioned embodiments, terminations for the systems are at the bottom, with two in the middle and two at ends. Alternatively, in the fabric article having an integrated bottom bus the four terminations can be designed to be close to each other as desired or in any location for the termination module. This reduces the pathway the electrical wire has to follow to the bus.

In summary, according to one aspect of the invention, a woven fibrous article adapted to generate heat upon application of electrical power comprises a woven fibrous body comprising a set of non-conductive warp yarns and a set of non-conductive filling or weft yarns, one of the set of non-conductive warp yarns and the set of non-conductive filling or weft yarns in one or more first regions comprising relatively more coarse yarns and in one or more second regions comprising relatively more fine yarns with electrical conductor elements extending generally along the second regions of the woven fibrous body, and the other of the set of non-conductive warp yarns and the set of non-conductive filling or weft yarns in the one or more first regions and in the one or more second regions comprising relatively more fine yarns, with a plurality of spaced apart electrical conductance heating elements in the form of conductive elements joined in the woven fibrous body with the other of the set of nonconductive warp yarns and the set of non-conductive filling or weft yarns to extend generally between opposite second regions of the woven fibrous body. The conductor elements are adapted to connect the plurality of spaced apart electrical conductance heating elements in a parallel electrical circuit to a source of electrical power.

In the one or more first regions, the set of non-conducting warp yarns comprises the relatively more coarse yarns and the set of non-conducting filling or weft yarns comprises the relatively more fine yarns. Preferably, the one or more second regions comprise selvedge or edge regions. Alternatively, in one or more first regions, the set of non-conducting warp in one or more first regions, the set of non-conducting warp yarns comprises the relatively more fine yarns. Preferably, the one or more second regions comprises spaced regions with one or more first regions disposed there between. The one or more second regions comprises a plurality of spaced second regions with one or more first regions disposed there between. A series of at least three electrical conductance heating elements of the plurality of electrical conductance heating elements are symmetrically spaced. Certain of the electrical conductance heating elements are asymmetrically spaced to provide selected localized regions of heating. Certain of the conductive elements have relatively lower linear resistance than other conductive elements, to provide selected localized regions of relatively greater heating.

Certain of the conductive elements of relatively lower linear resistance are symmetrically spaced and/or asymmetrically spaced. The conductive elements have the form of a conductive yarn. The fibrous body comprises hydrophilic material and/or hydrophobic material. The electrical conductor elements are adapted for connecting the plurality of spaced-apart electrical conductance heating elements in the parallel electrical circuit to a power source, e.g., of alternating current or of direct current, e.g. a battery mounted to the woven fibrous body. The electrical conductor elements are woven into the second regions of the woven fibrous body, e.g., with the non-conductive warp yarns or with the non-conductive filling or weft yarns. The electrical conductor elements comprise at least two yarns. The electrical conductor elements, at least in part, are applied as a conductive paste. The electrical conductor elements comprise a conductive wire. The electrical conductor elements, at least in part, are applied as a conductive hot melt adhesive. The electrical conductor elements comprise a conductive yarn or a conductive thread. The electrical conductor elements are attached upon a surface in a second region of the woven fibrous body. The electrical conductor elements are attached: by stitching, e.g. embroidery stitching, by sewing, by adhesive, by laminating, by mechanical fastening, and/or by strain relief fastening or combination of any of the techniques. The electrical conductance heating element has the form of a conductive yarn comprising a core, an electrical conductance heating filament, a sheath material wrapped about the core, and/or an over-wrap comprising insulating material wrapped about the core and the sheath. In one embodiment, the core may comprise the electrical conductance heating element and the sheath comprises insulating material. In another embodiment, the core comprises insulating material and the sheath wrapped about the core comprises the electrical conductance heating element. The electrical conductance heating element may instead have the form of a conductive yarn comprising an electrical conductance heating filament. The electrical conductance heating element has electrical resistivity in the range of about 0.1 ohm/cm to about 500 ohm/cm.

According to one aspect of the invention, a woven fibrous article adapted to generate heat upon application of electrical power is formed by a method comprising the steps of: joining a set of non-conductive warp yarns and a set of non-conducting filling or weft yarns to form a woven fibrous body, one of the set of non-conductive warp yarns and the set of non-conductive filling or weft yarns in one or more first regions comprising relatively more coarse yarns and in one or more second regions comprising relatively more fine yarns. The other of the set of non-conductive warp yarns and the set of non-conductive filling or weft yarns in the one or more first regions and in the one or more second regions comprises relatively more fine yarns, joining, in the woven fibrous body, with the other of the set of non-conductive warp yarns and the set of non-conductive filling or weft yarns, the plurality of spaced apart electrical conductance heating elements in the form of conductive elements, to extend generally between opposite second regions of the woven fibrous body, and connecting the plurality of spaced apart electrical conductance heating elements to electrical conductor elements extending generally along the second regions of the woven fibrous body to form a parallel electrical circuit for connection to a source of electrical power. Preferred embodiments of this aspect of the invention may include the following additional feature. The method further comprises the step of: finishing relatively more coarse yarn fibers in the one or more first regions of the set of non-conductive warp yarns and the set of non-conductive filling or weft yarns in a manner to avoid damage to electrical conductivity performance of the conductive elements joined with the other of the set of non-conductive warp yarns and the set of non-conductive filling or weft yarns of the woven fibrous body.

According to yet another aspect of the invention, a method of forming a woven fibrous article adapted to generate heat upon application of electrical power comprises the steps of: joining a set of non-conductive warp yarns and a set of non-conductive filling or weft yarns to form a woven fibrous body. One of the set of non-conductive warp yarns and the set of non-conductive filling or weft yarns in one or more first regions comprises relatively more coarse yarns and in one or more second regions comprises relatively more fine yarns and the other of the set of non-conductive warp yarns and the set of non-conductive filling or welt yarns in the one or more first regions and in the one or more second regions comprising relatively more fine yarns. Joining, in the woven fibrous body, with the other of the set of non-conductive warp yarns and the set of non-conductive filling or weft yarns, the plurality of spaced apart electrical conductance heating elements in the form of conductive elements, to extend generally between opposite second regions of the woven fibrous body, and connecting the plurality of spaced apart electrical conductance heating elements to electrical conductor elements extending generally along the second regions of the woven fibrous body to form a parallel electrical circuit for connection to a source of electrical power.

Preferred embodiments of this aspect of invention may include one or more of the following additional features. The method further comprises the steps of: finishing relatively more coarse yarns fibers in the one or more first regions of the set of the non-conductive warp yarns and the set of non-conductive tilling or welt yarns in a manner to avoid damage to electrical conductivity performance of the conductive elements joined with the other of the set of non-conductive warp yarns and the set of non-conductive filling or weft yarns of the woven fibrous body. The method further comprises the step of connecting the conductive element to a source of electric power and generating heat. The method further comprises the step of connecting the conductive element to a source of electric power comprising alternating current and generating heat. The method further comprises the step of connecting the conductive element to a source of electric power comprising direct current, e.g. in the form of a battery, which may be mounted to the woven fibrous article, and generating heat. The method further comprises the step of rendering elements of the woven fibrous body hydrophilic or rendering elements of the woven fibrous body hydrophobic.

Examples of objectives of the invention include to provide woven, fibrous electric heating articles, e.g., electric blankets, heating and warming pads, heated garments, etc., into which a plurality of spaced-apart electric conductance heating members, in the form of conductive elements, are joined with non-conductive yarns or fibers. The woven fibrous body of the heating article is subsequently subjected to a finishing process, e.g., relatively more coarse non-conductive yarns in selected (first) regions at one or both surfaces of the body may be napped, brushed, sanded, etc., in a manner to avoid damage to electrical conductance of the electric conductance heating elements, to form fleece. In a planar structure, such as an electric heating blanket, the electric conductance heating members are connected at their ends, e.g., in selected (second) regions of relatively more fine yarns along opposite selvedge or edge regions, or in spaced regions at opposite edges of first regions, of the planar body, i.e., of the blanket, and may be powered by alternating current or direct, e.g., by one or more batteries mounted to the body of the woven fibrous heating/warming article.

In another embodiment Chenille fabric construction may be used to generate surface features on the integrated conductive heating fabric article. Chenille construction may be used to generate surface characteristics without the need of brushing, napping or abrasion. Chenille yarns for patterned fabrics are produced by weaving conventional (woolen) pile yarns as weft across a cotton warp and cutting into warpwise strips, known as chenille fur. A modern spindle technique provides plain colored yarns. Chenille yarns may be made into Axminster constructions, flat woven fabrics or bonded fabrics. The construction of the fabric is in part governed by the specification of the chenille fabric: the spacing of the groups of warp threads governs the pile height, and the picks per decimeter define the “pitch” of the fabric. Weaving of the chenille fabric itself is carried out on a setting loom. A typical chenille fabric construction is similar to that of a two-shot wilton, but a catcher warp is added to bind the chenille fur. There are at least three warp beams: chain, stuffer and catcher warps. Sometimes a float warp passes above the ground warp ends but under the fur, to raise the fur to the top of the backing.

The weft is inserted, as in wilton looms, by shuttles—one shuttle for the jute weft and one for the fur. Four picks of jute and then one of fur are inserted. After inserting the fur, the loom Wools of New Zealand Unconventional methods of yarn production stops automatically with the chain and stuffer warp horizontal and the catcher warp raised. The weaver then sets the pile upright with the aid of a steel comb before re-starting the loom to beat up the fur. Alternatively, the pile is inserted by a travelling arm supplied from a can or basket of loose fur. In this way, crushing of the fur caused by winding on cops is avoided and setting the pile upright is facilitated. Chenille-axminster manufacture is clearly labor-intensive compared with gripper-jacquard axminster (especially the electronic jacquard versions).

By incorporating unset chenille fur as weft in a flat fabric, the pile material becomes located on both sides of the fabric. Reversible rugs with a unique random pile lay have been produced in this way. Using a tapestry weave, this technique may be extended to produce two-color reversible designs.

Bonded Fabrics—The former Templeton Fabrics Ltd., UK, the original manufacturer of chenille axminster fabrics, also operated a system of bonded-fabric manufacture based on plain (or color twist) pile yarns. Strips of Chenille fur, set into a V shape, were pressed into a layer of adhesive (latex) on jute backing fabric. The laminate was dried and cured in an oven to give a velour fabric that performed well. The system was displaced by the more productive face-to-face fabric bonding system. Although not a Chenille process, the Bondi system for manufacturing wool rugs operated by Karastan, USA, for a number of years, could provide ideas for a future system for manufacturing Chenille fur. As with Chenille Axminster, the Bondi process assembled the pile yarns into a design by weaving them into a preliminary fabric. In the Bondi process, however, the preliminary fabric was precisely folded into a block and one end of the block was glued to a backing fabric. A slice of pile was cut off, and the procedure repeated until the block was exhausted. The relevant point is that the temporary fabric carrying the design was woven on an electronic loom, having an electronic weft selection system. For beautiful appearance and softness, Chenille yarn has become the choice of fabric designers for many items. The softness and sheen of Chenille improves the appearance and hand of thousands of everyday items, including sweaters, outerwear fabrics, upholstery and curtain fabrics, throws and blankets, and area rugs. Chenille is a pile yarn that has been produced commercially since the 1970s.

In the early years, the machinery used for commercial production resulted in chenille with variable characteristics. Modern machinery was introduced in Europe and North America, in the early 1990s, and today's Chenille is a reliable and beautiful yarn that is gaining in popularity. CIMA is dedicated to improving industry manufacturing practices through education, to assure easier use of this beautiful yarn. Chenille is a difficult yarn to manufacture, requiring great care in production. Due to the nature of Chenille's pile direction, pile completeness (or lack of missing pile), and strength-to-bulk relationship, great care must be taken in converting chenille into final articles. The following information is designed to give an understanding of the Chenille manufacturing process and the technical specifications necessary to properly convert Chenille yarn into finished goods.

Chenille yarn consists of short lengths of spun yarn or filament that are held together by two ends of highly twisted fine strong yarn. The short lengths are called the pile and the highly twisted yarns are called the core. Chenille yarn can be made from many different types of fibers and yarns. Most common are cotton, viscose (rayon), acrylic, and polypropylene (olefin). Chenille yarn can be made in many different sizes, ranging from as heavy as Nm 0.2 to as fine as Nm 12.0. Chenille yarn is manufactured on a machine that is designed to bring the pile yarns and core yarns together. During manufacture, the pile yarns are wrapped around a short stem of polished metal, called a caliper, through which a blade passes to cut the pile yarns into short lengths.

The core yarns are pressed onto the short lengths with a rotating metal wheel. The resulting yarn is then fed onto a traditional ring twisting take up mechanism. In the twisting process, the two ends of core yarn twist and trap the short ends of pile between the core yarns. The size of the caliper determines the diameter of the resulting yarn. The size and number of the pile yarns and how much of them are fed onto the core determines the count of the yarn. Chenille is manufactured in a two step process. Step one is the manufacture of the Chenille onto a Chenille bobbin, and step two is the rewinding of the Chenille onto a cone or dye tube. An electronic clearer is located in the yarn path of step two to detect lengths of yarn that have pile missing.

When the electronic clearer detects a section of missing pile greater than the minimum setting specified (usually 3 mm), a cutter is electronically activated. The yarn is cut, and the winder operator then pulls the yarn back and cuts out the missing pile section, reties the yarn, and continues winding the package. The electronic clearer devices are almost 100% effective. The Chenille manufacturing process creates pile that lies in one direction. When woven into a fabric, Chenille reflects light differently when viewed from different directions. This is a unique and desirable characteristic of Chenille goods. Because of this, strict control of the pile direction must be maintained during both the steps of manufacturing the Chenille and also all subsequent processes required to convert the Chenille into a finished article. Following step one of manufacturing, the yarn has direction one. After the winding process in step two, the yarn has direction two. The chenille yarn producer has taken all the necessary steps to ensure that the Chenille yarn is all in the same direction when it is shipped to the user. The Chenille yarn user must take care to maintain the same pile direction throughout manufacturing.

For example, with yarn sold on dye tubes and coned after dying, if rewinding is necessary (as in the case of cross-wound yarn or packages that are too hard or soft), the yarn must be rewound TWICE so that all the yarn remains in the original pile direction. If this rule is not strictly observed, streaks will result in the final fabric. The Chenille manufacturing process creates pile that lies in one direction. When woven into a fabric, chenille reflects light differently when viewed from different directions. Because of this, strict control of the pile direction must be maintained during both the step of manufacturing the chenille and also all subsequent processes required to convert the chenille into a finished article.

Chenille can be processed on warp knitting machines, weft Raschel machines, flat bed, and circular knit machines without any difficulties. The type of machine used will depend on the cloth characteristics desired and the purpose of the finished product. As with other yarns, uniform winding tension is necessary when warp beams are made. In order to avoid excessive strain on the Chenille during the warping process, the thread should be supported by guiding devices that move together with the yarn. If this is not possible, then the diverting points-in the creel, for example, should be designed as guides with a larger radius.

As is sometimes done with other fancy yarns, the guide bars for the Chenille should be designed as guiding tubes. A relatively high tension is necessary for producing flawless quality goods; because of this, normal eyes lead to pile displacement in the Chenille. Feed tension should be controlled in such a way that during the looping process the needle does not exert too much friction on the yarn. This causes displacement of the pile, which can lead to bare spots between the Wales. Since the maximum thread tension is dependent on the degree of guiding, it cannot be given as a fixed value, but must be determined by suitable tests. Processing Chenille on a weft Raschel entails fewer problems than on a warp knitting machine (Chenille by its very nature has the tendency to lose its shape, every possible attention should be taken to prevent it). Knitting alternately from various packages will give to the final product a consistent appearance. In order to prevent pile loss it is advisable to knit with a tight and fine stitch. To achieve a better result in size consistency and shaping it is suggested to knit Chenille together with a finer support yarn. Jacquard styling enhances the softness, brightness, and bulkiness of Chenille. All Chenille yarns that are to be knitted should be specified to have a knit wax applied. If for various reasons the yarn cannot be knitted within 30 days, it should be rewaxed, and to avoid direction problems it has to be rewound twice. As with woven fabric, pile direction must be strictly maintained.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

We claim:

1. A woven fabric system, comprising:
at least one top fabric layer;
at least one heating element comprising:
at least two electrically conductive buses, wherein said electrically conductive buses are parallel to each other;
a series of electrical resistive wires located between said at least two electrically conductive buses; and
a horizontal electrically conductive bus connecting said at least two electrically conductive buses to each other; and
at least one bottom fabric layer, wherein said top fabric layer, said heating element, and said bottom fabric layer are connected to prevent said heating element from moving within said system.

2. The system of claim 1, wherein an electrical resistive wire is a bare electrical wire comprising a bundle of conductive filaments.

3. The system of claim 1, wherein an electrical resistive wire is a series of electrical wires wrapped around an insulative core.

4. The system of claim 1, wherein said electrical resistive wires have a continuous coating.

5. The system of claim 1, wherein said electrical resistive wires have a discontinuous coating, wherein a portion of said electrical resistive wires that is exposed due to not being covered by said coating, also referred to as an opening, is in electrical communication with at least one of said conductive buses.

6. The system of claim 5, wherein a width of said conductive bus that is in electrical communication with said opening is wider that said opening.

7. The system of claim 1, wherein said horizontal electrically conductive bus further comprises at least one terminal for receiving power from a power source.

8. The system of claim 1, wherein said heating element has an asymmetrical distribution of said electrical resistive wires defining more than one section, and wherein a single section is defined by an equal distance between adjacent electrical resistive wires, said single section being defined by a specific amount of heat per unit square area.

9. The system of claim 1, wherein said heating element further comprises at least one selvedge.

10. The system of claim 1, further comprising non-conductive yarn that holds said electrical resistive wires in place within said system.

11. The system of claim 1, wherein the at least two electrically conductive buses are segmented to achieve separate zones within the woven fabric system.

12. The system of claim 1, wherein said heating element is a first heating element, and wherein said system further comprises a second heating element, said top fabric layer and said first heating element being within a single first layer, and said bottom fabric layer and said second heating element being within a single second layer.

13. The system of claim 1, wherein said top fabric layer, said heating element, and said bottom fabric layer are connected using a series of tack points.

14. The system of claim 1, wherein said system comprises at least two zones, each zone having its own heating element, and wherein each of said zones may be individually controlled.

15. A heating element, comprising:
at least two electrically conductive buses, wherein said electrically conductive buses are parallel to each other;
a series of electrical resistive wires located between said at least two electrically conductive buses;
a horizontal electrically conductive bus connecting said at least two electrically conductive buses to each other, wherein said horizontal electrically conductive bus contains at least one terminal for receiving power from a power source.

16. The heating element of claim 15, further comprising insulative warp and weft yarns.

17. The heating element of claim 15, wherein said heating element has an asymmetrical distribution of said electrical resistive wires defining more than one section, and wherein a single section is defined by an equal distance between adjacent electrical resistive wires, a single section being defined by a specific amount of heat per unit square area.

18. The heating element of claim 15, wherein said at least two electrically conductive buses are segmented to achieve separate zones within the woven fabric system.

19. A heating element roll, comprising
at least two electrically conductive buses, wherein said electrically conductive buses are parallel to each other;
a series of electrical resistive wires located between said at least two electrically conductive buses;
a series of horizontal electrically conductive buses, wherein each horizontal electrically conductive bus connects said at least two electrically conductive buses to each other, said heating element roll being defined by a series of sections, wherein each section contains said at least two electrically conductive buses, a portion of said series of electrical resistive wires, and a single horizontal electrically conductive bus.

20. The heating element roll of claim 19, wherein said heating element roll further comprises selvedges.
